(19) United States
(12) Patent Application Publication
(10) Pub. No.: US 2025/0094191 A1
(43) Pub. Date: Mar. 20, 2025

(54) SYSTEM AND METHOD FOR CUSTOM ACTION CREATION IN AUTOMATION WORKFLOWS

(71) Applicant: Zapier, Inc., San Francisco, CA (US)

(72) Inventors: Bryan Helmig, San Francisco, CA (US); Brian Corbin, San Francisco, CA (US); Justin Deal, San Francisco, CA (US); Vitor Balocco, San Francisco, CA (US); Lisa Orr, San Francisco, CA (US); Brady Skaurud, San Francisco, CA (US)

(21) Appl. No.: 18/891,679

(22) Filed: Sep. 20, 2024

Related U.S. Application Data
(60) Provisional application No. 63/584,044, filed on Sep. 20, 2023.

(51) Int. Cl. G06F 9/451; G06F 9/54

(52) U.S. Cl. CPC G06F 9/453; G06F 9/541

(57) ABSTRACT

A method and system for custom action creation in automation workflows is disclosed. In some embodiments, the method includes receiving a request for creating an application extension from a user, the application extension including at least one custom action. The method includes determining, using one or more trained artificial intelligence (AI) models, one or more existing application extensions and associated parameters from a plurality of connected applications. The method also includes generating one or more first graphical interfaces to present a recommendation to the user, the recommendation including the one or more existing application extensions and associated parameters. The method further includes receiving a selection of the recommendation from the user and, in response to receiving the selection, creating the application extension based at least on the recommended parameters.

### CROSS REFERENCE TO RELATED APPLICATION

This application claims the benefit of U.S. Provisional Patent Application No. 63/584,044, titled “System and Method for Custom Action Creation in Automation Workflows,” and filed on Sep. 20, 2023, the entire content of which is incorporated by reference herein.

### TECHNICAL FIELD

This disclosure relates to an application extension system that creates custom actions in automation workflows using artificial intelligence models.

### BACKGROUND

Applications (hereafter referred to as “apps”) and associated data power the way that various tasks get implemented in a computer and network environment. Manually integrating countless apps is slow, costly, or even impractical for some users (e.g., business users, personal users). Platforms are currently being developed to connect different apps and services to automate workflows, but the current systems face challenges in increasing system flexibility, reducing operation complexity, facilitating customization, etc.

### SUMMARY

To address the aforementioned shortcomings, a method and a system for custom action creation in automation workflows are disclosed herein. The method receives a request for creating an application extension from a user. The application extension includes at least one custom action. The method determines, using one or more trained artificial intelligence (AI) models, one or more existing application extensions and associated parameters from a plurality of connected applications. The method also generates one or more first graphical interfaces to present a recommendation to the user, and the recommendation includes the one or more existing application extensions and associated parameters. The method further receives a selection of the recommendation from the user, and in response to receiving the selection, creates the application extension based at least on the recommended parameters.

In response to the user rejecting the recommended application extensions, one or more second graphical interfaces are generated to provide instructions for the user to create the at least one custom action, values are populated to one or more fields of the one or more second graphical interfaces based on the associated parameters, and the populated values are then provided to the user to reduce user input in creating the at least one custom action. In response to the user accepting a recommended application extension, the accepted application extension is used to complete creating the application extension. To determine the one or more existing application extensions and associated parameters, at least one of semantic search and AI prompting is performed. In some embodiments, one or more text responses to request additional information or to confirm user requirements are generated, and determining the one or more existing application extensions and associated parameters is based at least on the user requirements. Information of the plurality of connected applications is also synchronized. One or more coding interfaces are generated for a user to run a software program and create the application extension. The application extension can be shared with one or more other users. The one or more AI models are trained using a secured application programing interface (API) database. In some embodiments, the request for creating the application extension comprises a natural language prompt describing the at least one custom action.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 illustrates an exemplary diagram of an overall automation system, according to some embodiments.

FIG. 2A illustrates an exemplary process of creating an app extension for automating custom actions, according to some embodiments.

FIG. 2B illustrates an exemplary graphic user interface (GUI) presented to a user for creating an app extension, according to some embodiments.

FIG. 3 illustrates an exemplary GUI for a user to choose an automation approach, according to some embodiments.

FIGS. 4A and 4B illustrate exemplary GUIs for creating an app extension based on manual input, according to some embodiments.

FIGS. 5A and 5B illustrate exemplary GUIs for creating an app extension based on AI learning, according to some embodiments.

FIGS. 6A and 6B illustrate exemplary GUIs for creating an app extension using a coding interface, according to some embodiments.

FIG. 6C illustrates an exemplary processing flow for creating an app extension based on code building and execution, according to some embodiments.

FIG. 7 illustrates an exemplary app extension system for implementing the technology described herein, according to some embodiments.

FIG. 8 illustrates a flowchart of creating an app extension in automation workflows, according to some embodiments

FIG. 9 illustrates a block diagram of an example computer system that may be used in implementing the technology described herein, according to some embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

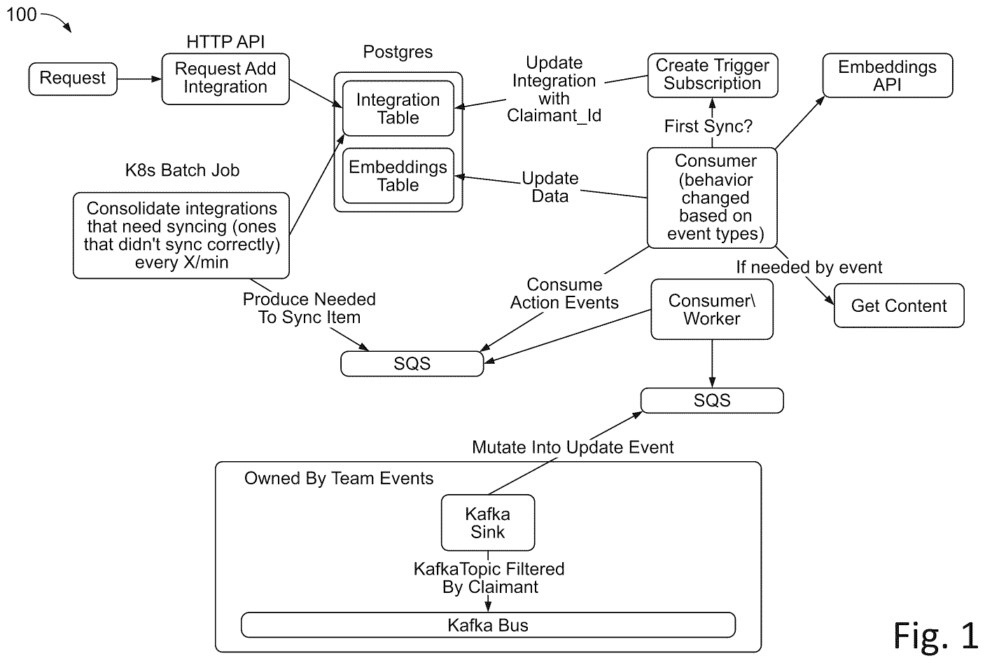

As more and more work processes become digitized through the use of cloud applications, tasks that are trivial in isolation (e.g., uploading files, creating calendar events, sending messages) can accumulate and take away chunks of time and resources from more useful tasks. Therefore it is imperative to find a way to efficiently and accurately integrate and connect apps and services (e.g., cloud-based services) and automate certain tasks (e.g., repetitive tasks) based on data exchange between the apps and services. Underneath the app/service integration, there are many technical problems. The app integration, specifically, automating workflows between various apps includes at least communications between the apps through application programming interfaces (APIs), which generally requires a requesting user to have the knowledge about what method is used for API communications, parameters used for the communications, etc. It is hard to create a custom action that satisfies the user's needs based on the user's natural language request without any computer coding from the user. In workflow automation, data access and search across apps/services is another critical but complex problem. The present system provides technical solutions to these technical problems as described below with reference to FIGS. 1-9.

The present disclosure describes an online automation and customization system, where a user can select two or more apps and connect the selected apps to to customize and automate repetitive tasks. For example, the present system can be configured to automatically generate and send out a custom tweet after a user publishes a post, in response to receiving a one-time input (e.g., trigger, action as described below) from the user. The present system connects thousands of applications such that different types of actions may be customized and created. For example, the present system allows users to share new posts on Linkedin™, add events of selected apps to Google Calendar™, receive alerts in Slack™ when the user receives emails with attachments automatically downloaded to Dropbox™, etc.

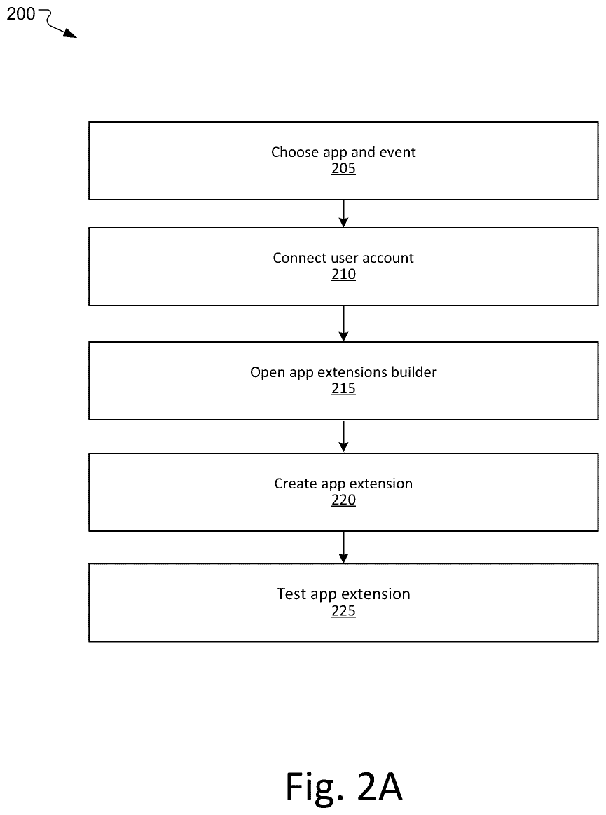

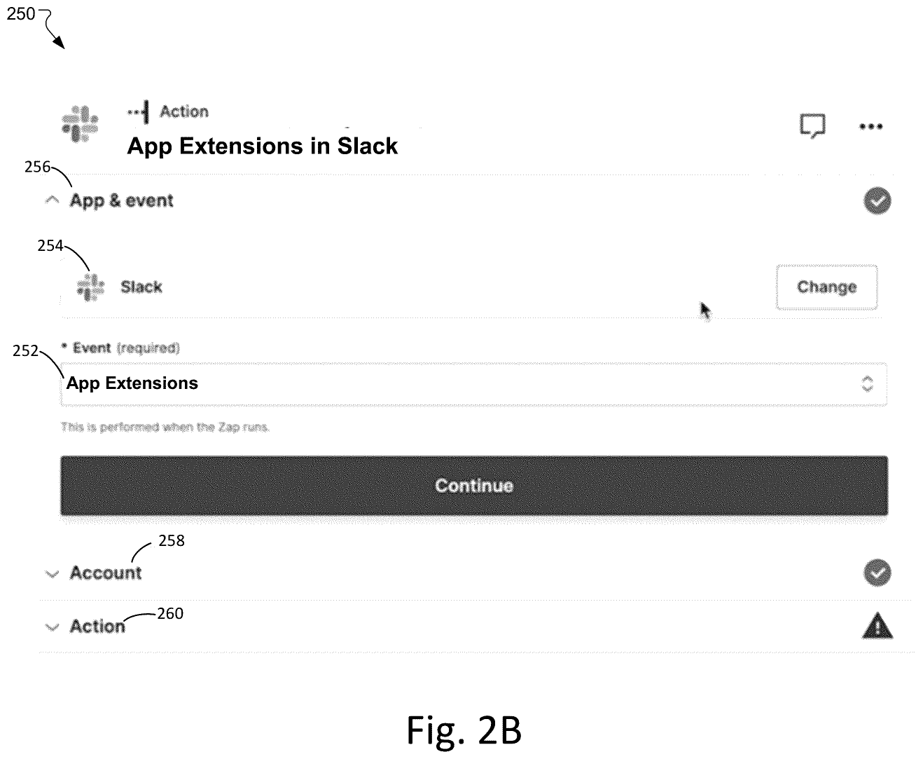

With the integration of thousands of apps, the present system has embedded many automation as default actions that can be directly applied for execution by a user. But sometimes the user may need an action that is not yet available. In some embodiments, the present system provides an app extension feature for the user to create, edit, and share his/her custom actions, which will be described below in detail with reference to FIGS. 2A-7.

Advantageously, the present system enables a user to meet his/her task automation needs through app extensions without coding or relying on developers to build integration. On the other hand, the present system also provides an option for a coder to create a flexible automatic action through a coding interface of the app extensions. When creating an automation, the user may look up parameters associated with an action (e.g., referring to app specification) to set up the action. In some embodiments, one or more artificial intelligence (AI) models may be trained to provide the user recommendations (e.g., possible actions and/or possible parameters) to create the action.

### Overall Implementation

The present system is an automation tool that helps users create smart and customized workflows based on connecting thousands of apps and services. Example apps include Asana, Azure DevOps, Chime, Google Calendar, Google Docs, Instagram, LinkedIn, Slack, Reddit, etc. While the present system provides numerous automation by default, a user who needs an extra action can create and customize the action through the feature of app extensions.

FIG. 1 illustrates an exemplary diagram 100 of an overall automation system. The present system may integrate various applications, transfer data, and realize process automation by automatically linking and synchronizing the actions of the apps and services, so that recurring processes can be executed automatically.

An automated workflow, which links together users' apps, includes two fundamental functions: a trigger and a subsequent automated action. The trigger is the first event that sets the automated workflow in motion and starts the action that has been set up. In other words, a task is triggered at one point so that an action is performed in a subsequent point. A diagram that sets up steps for the automated workflow is shown in FIG. 1.

It should also be noted that an automated workflow as described herein may be configured to perform a custom action that signals and controls the operation of one or more hardware devices when a specified trigger condition is met. For example, when a first app installed on a user mobile device shows that the user is within a pre-defined distance of the user' home at a specific time range, this trigger event would cause one or more signals to be sent from a connected, second app to control the operations of smart home devices such as turning on/off air conditioner, operating a device to play music, etc.

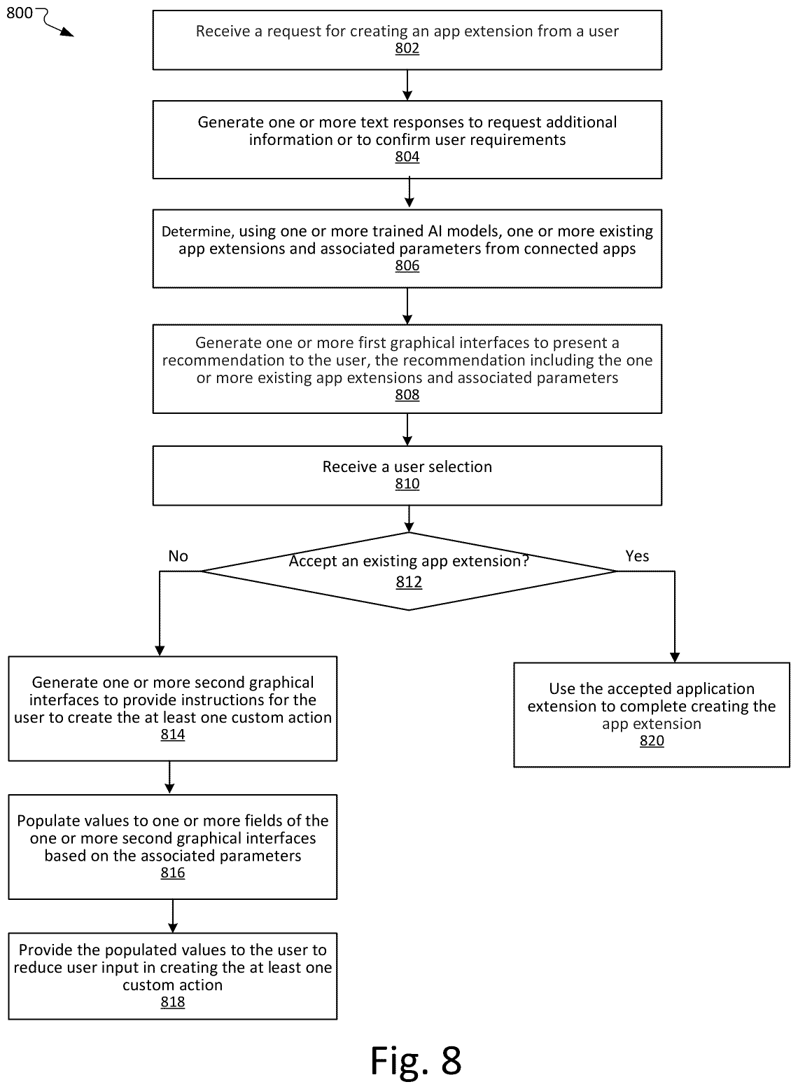

In some embodiments, an app extension can be used to create a custom or customized action. The app extension also allows a user to extend functionality and content beyond the user's app and make it available to other users while these users are interacting with other apps. In some embodiments, the app extension allows the user to build custom actions using hypertext transfer protocol (HTTP) requests based on an app's public API. FIG. 2A illustrates an exemplary process 200 of creating an app extension for automating custom actions, according to some embodiments. In some embodiments, process 200 is implemented by a computer system in FIG. 8 in conjunction with other computer and network resources (not shown).

Process 200 starts at step 205, where a user can choose an app and event, e.g., from a respective drop-down menu in an editor. The app menu may include at least a subset of apps connected by the present system. The event menu may include default actions, available custom actions created by other users, as well as an “app extensions” option. Example actions include sending a push notification, adding a reminder, finding a user, adding a user to a group, removing a user from a group, creating a subscription, etc. If the user cannot find an action that is most descriptive to meet the user's needs, the user may select the “app extensions” option to create his/her own app extension or custom action.

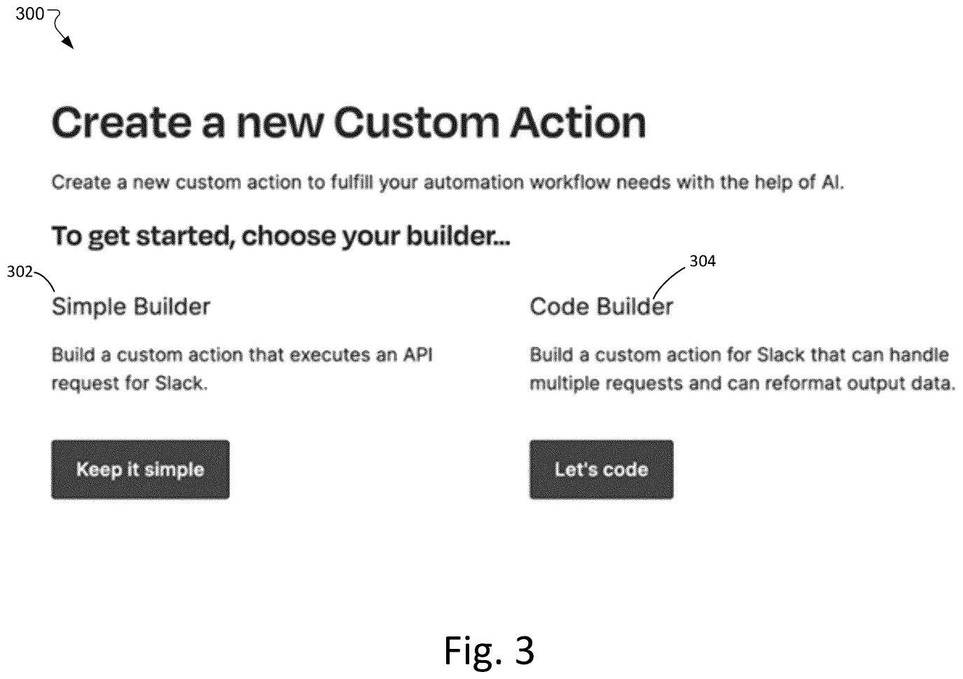

At step 210, the user's account is connected. If the user already has an account created and connected to the present system for the chosen app, the user can select it from an account menu. Otherwise, a new account will be created and connected for the user. The present system uses the new account to authenticate the user across different apps and access and retrieve data from the apps. Once the user's account is authenticated and connected, at step 215, an app extension builder can be launched upon a user selection. The app extension builder is triggered to create an app extension that meets the user's specific needs at step 220. The process of creating the app extension will be described in detail in FIGS. 3-6C.

FIG. 2B illustrates an exemplary graphic user interface (GUI) 250 presented to a user for creating an app extension. In this example, a user chooses to create an app extension 252 in app “Slack” 254 from the menu of “App & event” 256. The user can continue to have his/her account connected using the “Account” option 258 and then trigger an app extension builder using an “Action” option 260.

Referring back to FIG. 2A, once the app extension and associated action that were not yet available in the present system are created, at step 225, the app extension/action can be tested. Testing the app extension is to ensure that the associated action works as the user expected. In some embodiments, the present system may generate and present one or more GUIs for a user to input values to any required fields and send a test request. Upon the execution of the test request given the user input data, the user can review an API response in the GUIs. If the response includes an error, the present system may analyze it and present the user with a suggestion or solution to correct the error. The present system may allow the user to download or copy the full response data if the user needs to further troubleshoot the error. In some embodiments, the present system also generates a response log for the response, which censors sensitive information such as API keys or authentication tokens.

Based on an app's public API and using HTTP requests, the present system allows the user to create (as discussed above), edit, and use the missing functionality with the app extension. In some embodiments, the app extensions created by a user may be shared and made available to other authorized users. For example, the present system can be configured to make an app extension available to a user's teammates, allowing the users in the same team to benefit from what the user has built.

### App Extensions Creation

In some embodiments, the creation of app extensions may work in three different ways. First, the present system may generate and present one or more GUIs to instruct a user to input the necessary data to fulfill the request to create an app extension. This approach outlines the critical elements needed for task automation and thus allows the user to move or copy at least some of these elements in creating different related task automation. However, this approach requires a certain amount of user effort.

To minimize manual operations, the present system may train and use one or more AI models in the second approach. Instead of receiving from the user input about specific parameters required for creating the app extension, the AI models can determine and propose app extensions and associated parameters for the user, thereby significantly improving user experience and increasing the accuracy and efficiency of action creation.

In some embodiments, the AI models may determine the app extensions and associated parameters using a combination of action descriptions and surrounding contexts in a workflow. An action description may include a natural language description of an action or a workflow involving multiple actions. An example action description may be “send a slack message to a patent channel,” where the action (e.g., send a message), the app (e.g., Slack), the input (e.g., channel and message), as well as specific values of certain inputs (e.g., “patent” channel) would be identified and utilized by the AI model to determine the app extensions and associated parameters.

The surrounding contexts may also provide clues to the AI models such that the models can propose a useful app extension and/or associated parameters. The surrounding contexts include, but are not limited to, a title of a workflow, a description of steps in the workflow, app(s) and authentication used in the steps, values of parameters of surrounding steps, and currently available actions. In some embodiments, the surrounding context may be supplied to an AI model in the form of a prompt. The prompt may effectively automate the creation of action descriptions by providing instructions to the AI model and generating meaningful, coherent, and detailed action descriptions.

The first and second approaches are generally easy and convenient for a user since they are no-code and visualized approaches. An individual user does not need to write any software program to achieve the goal of creating the app extension. However, if a user wants to handle multiple API requests in a single automation/action or add some other unique features, the present system also provides a coding interface for the user to run his/her program and create the app extension in a third approach.

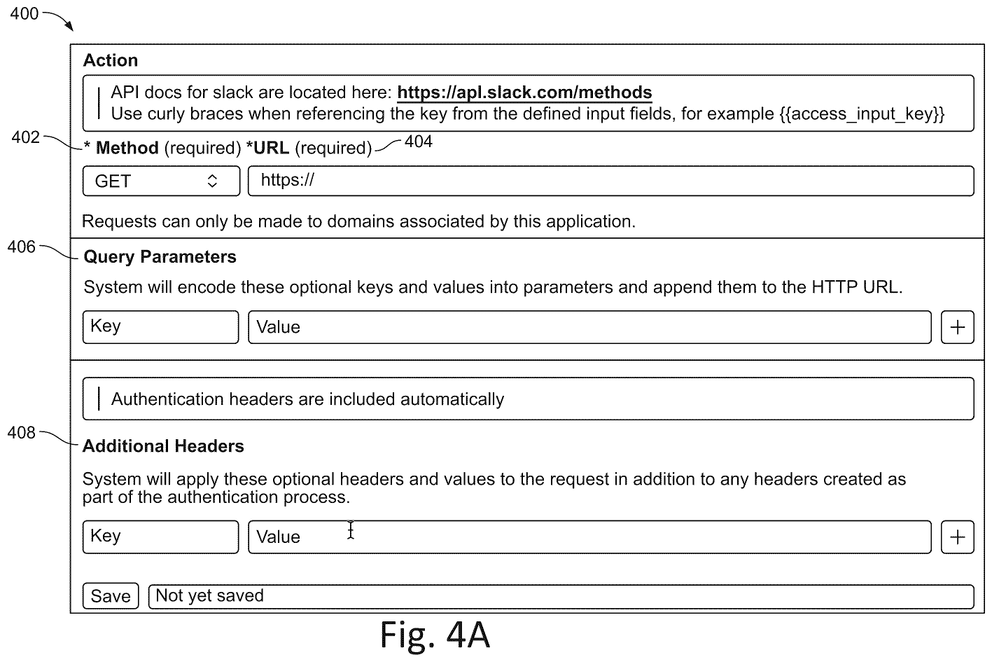

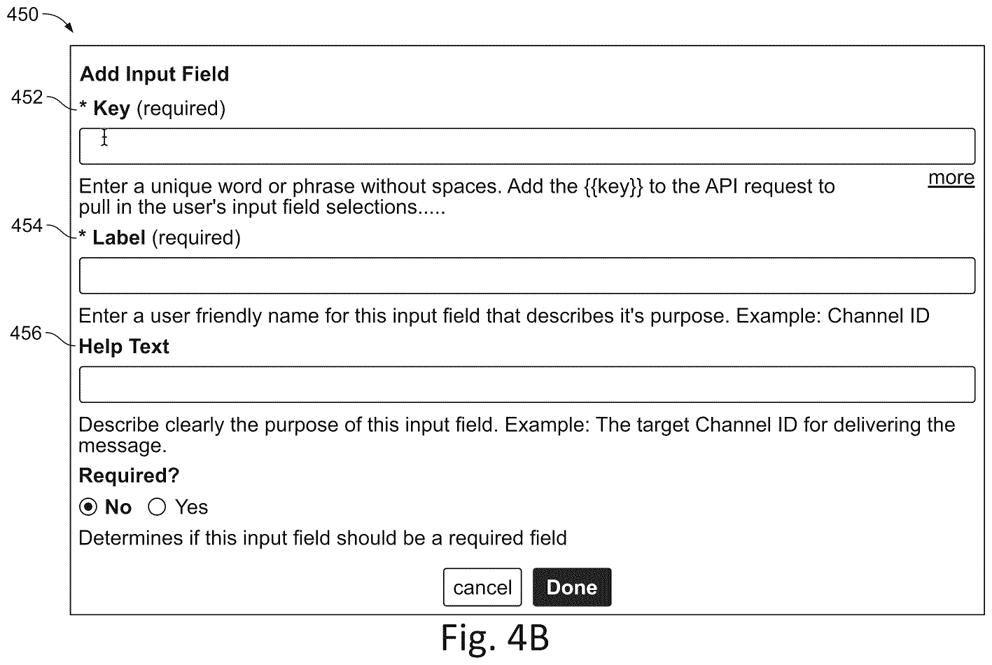

FIG. 3 illustrates an exemplary GUI 300 for a user to choose an automation approach. As described above in FIG. 1, an app extension builder is triggered to create an app extension and associated action. As depicted in FIG. 3, this app extension builder can be a simple builder 302 or a code builder 304. If the user selects the simple builder 302, the first and/or second approaches may be implemented to create a new custom action of an app extension. The user can also select the code builder 304 to code directly and leverage prompting to build a custom action, where prompting includes using a natural language prompt to describe a desired action. FIGS. 4A-6 describes the different approaches used to create an app extension (i.e., step 120 in FIG. 1).

FIGS. 4A and 4B illustrate exemplary GUIs for creating an app extension based on manual input. This is the first automation approach. The app extension is an advanced feature that allows a user to create custom actions for existing app integrations using HTTP requests. To manually provide the proper information, the user generally needs some familiarity with sending HTTP requests, APIs, and reading API documentation. If an app's API has changed, the user may need to update the app extension.

In some embodiments, the app extension builder allows the user to configure an API request, add input fields, and/or add other information needed for the app extension. As shown in the example GUI 400 of FIG. 4A, the user is prompted to add an API request, that is, telling the system how to send data to an app's API. The API request can be executed based on the user input in the required fields such as “Method” 402 and “URL” 404. Depending on the API request, the user may also provide input to other fields such as “Query Parameters” 406 and “Additional Headers” 408. Similarly, using the example GUI 450 in FIG. 4A, the user may send input data with the API request in input fields 452-456.

The present system may populate data in GUIs 400 and 450 to help the user enter the required data. For example, GUI 400 may include a dropdown menu for the user to select get, put, or other API methods in “Method” field 402, or directly fill in the field of authentication header in 408 for the user based on the app's authentication to connect to the user's app account. But the user has to find and fill in the correct values in some other fields, for example, relying on the app's API documentation for the full URL of the endpoint in “URL” field 404. Even if the link to API documentation is provided in the GUIs for quick reference of the user, the user may still need to manually find and enter the required information, which can be error-prone and time-consuming.

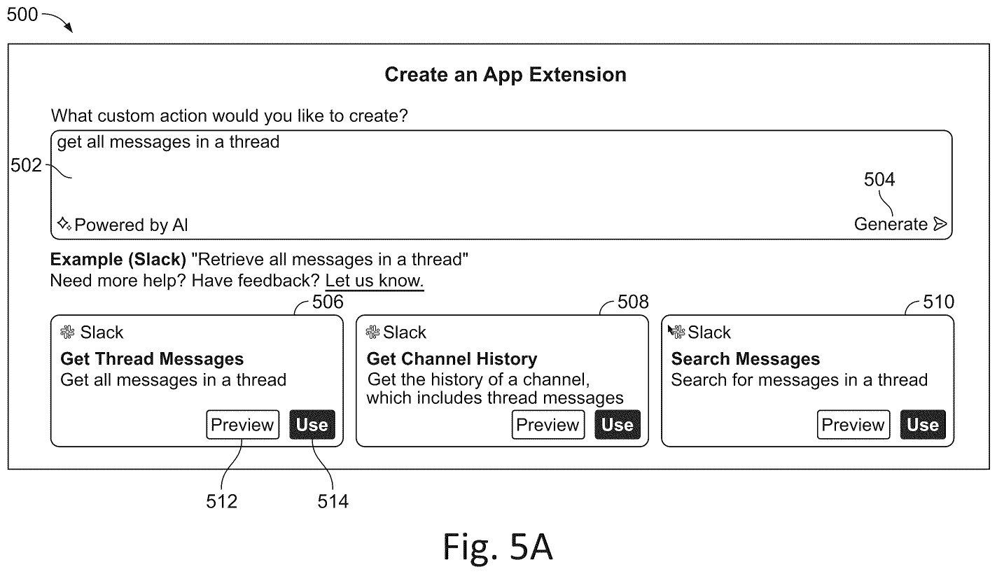

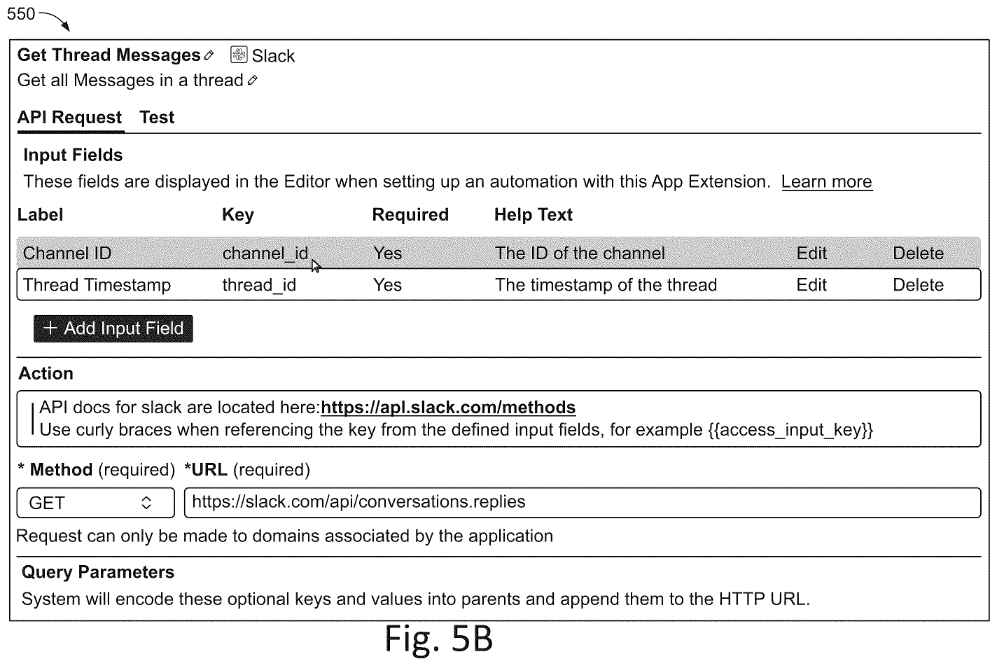

FIGS. 5A and 5B illustrate exemplary GUIs for creating an app extension based on AI learning. This is the second automation approach. Instead of finding and inputting parameters required to create an app extension, as shown in GUI 500 of FIG. 5A, a user merely inputs “getting all messages in a thread” in field 502 and selects the “Generate” option 504. As a result, the app extension builder trains one or more AI models to learn from collected data and generates recommendations about the app extension (e.g., three recommendations in 506-510) using the trained model(s).

As compared to FIGS. 4A and 4B, the user input 502 in the example of FIG. 5A is a natural language prompt describing a custom action rather than any machine language. The user tells the app extension builder what the user wants to do without making an effort to find expressions that the system can recognize and interpret. For example, the user does not need to read an API specification to find an exact URL or add double curly braces for certain parameter values. By removing content, format, and/or other system constraints, this approach greatly improves user experience and reduces manual errors.

In some embodiments, the recommendations are relevant app extensions. These are default actions initially included in the system or app extensions that have been created by other users. In FIG. 5A, when the user wishes to create an action to receive all messages in a thread, the app extension builder determines and presents the relevant extensions “Get Thread Messages” in 506, “Get Channel History” in 508, and “Search Messages” in 510. In some embodiments, the app extension builder may determine that an app extension is relevant to the user's to-be-created action based on text recognition (e.g., natural language processing) and the machine learning process of one or more AI models.

The user can determine whether to take one of the recommended app extensions 506-510 to achieve his/her goal of getting all messages in a thread in 502. For example, the user can select the “Preview” option 512 to view the API, the parameters (e.g., query parameters such as key, channel, etc.), and input fields associated with the app extension 506, as shown in GUI 550 in FIG. 5B. If this app extension works for the user, the user can select the “Use” option 514. As a result, the information of the entire app extension will be populated for the user. In this way, the app extension builder replaces the custom action creation process (e.g., the first approach) shown in FIGS. 4A and 4B with an existing app extension to satisfy the user's needs, without the user knowing the content and format of each input. Even if the user decides not to use any of the recommended extensions/actions, relevant inputs have been defined by the system for the user in the preview GUI 550 of FIG. 5B. This significantly relieves data input burden from the user when the user returns to the process in FIGS. 4A and 4B to create the action.

The AI-based action creation process shown in FIGS. 5A and 5B benefits in various aspects. It provides users more choices, which may completely remove the creation process with a recommended existing action, or at least provide some clues to facilitate the creation process. It also gives the user the discoverability of other options that are included in the app but the user is not aware of. For example, the user may use “Search Messages” extension 510 to automate the message search in the future regardless of whether the user would use it this time.

As noted above, the first manual-input approach (i.e., FIGS. 4A and 4B) and the second AI-powered approach (i.e., FIGS. 5A and 5B) may be conducted separately or in combination depending on the user's action description, the accuracy of the recommendation, the user's decision, etc.

In some embodiments, the app extension builder relies on an OpenAPI to determine the recommendation using AI models. In other embodiments, an internal and mirror OpenAPI database may be composed and built from public API specifications or documentation stored in online resources. The internal API database can filter out unreliable content and store only accurate and secure information. The app extension builder may train the AI models based on the secured internal API database, which will accurize and speed up the recommendation generation process.

Using the above two approaches, the app extension builder (i.e., simple builder 302 in FIG. 3) may build a custom action for a user that executes a single API request for an app (e.g., Slack). However, using a code interface, the app extension builder (i.e., code builder 304 in FIG. 3) may allow the user to build a custom action that can handle multiple API requests for the app and can reformat output data.

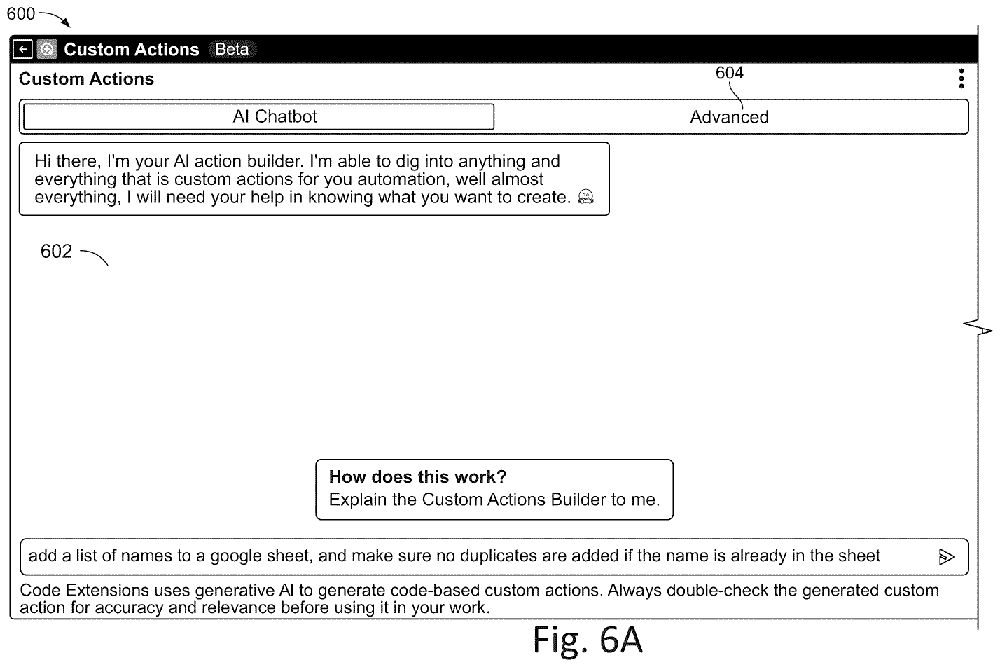

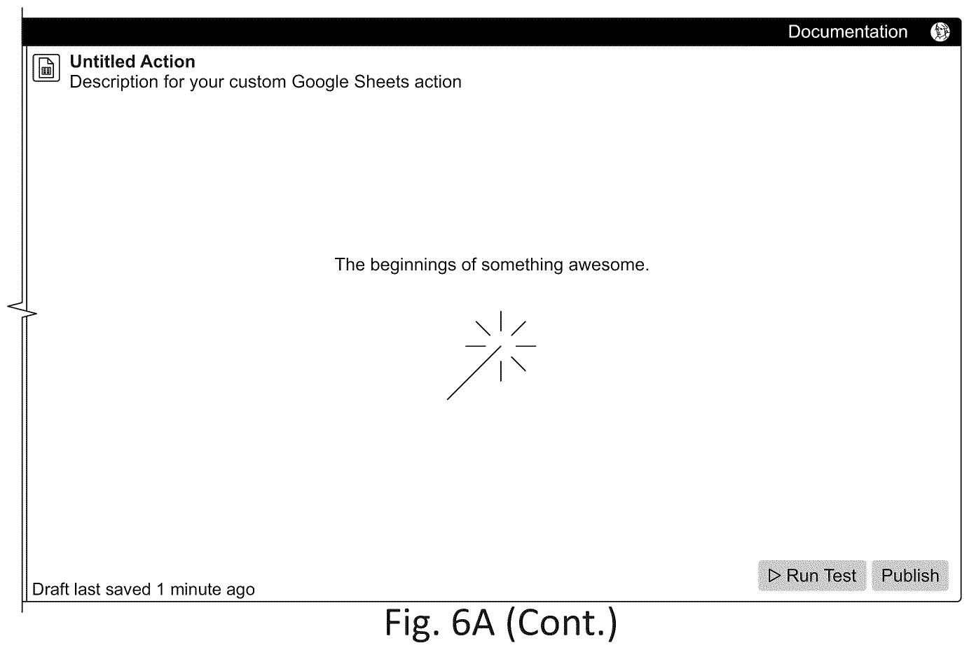

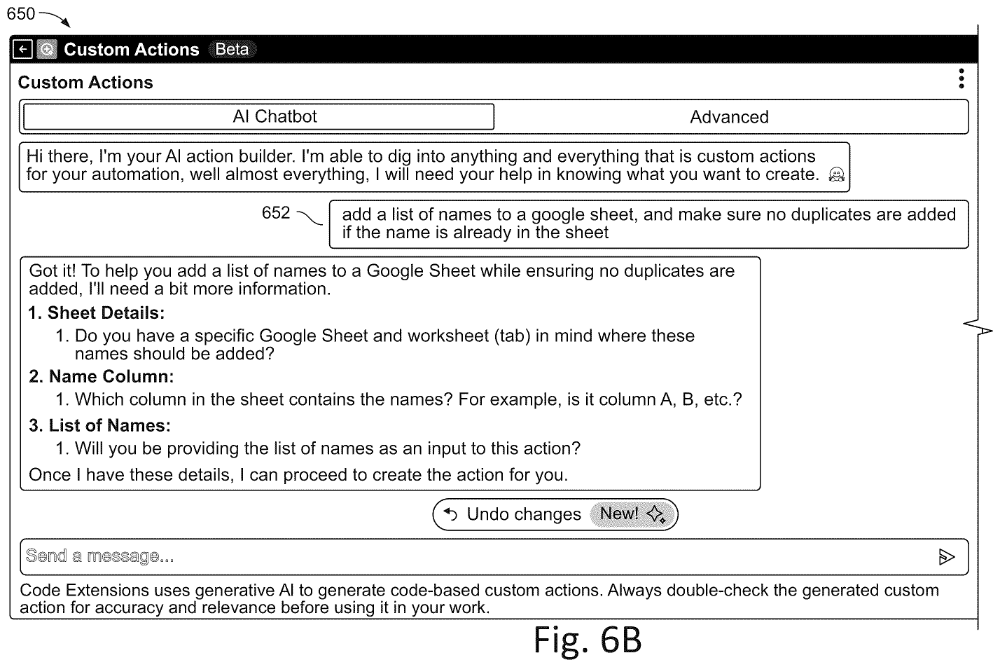

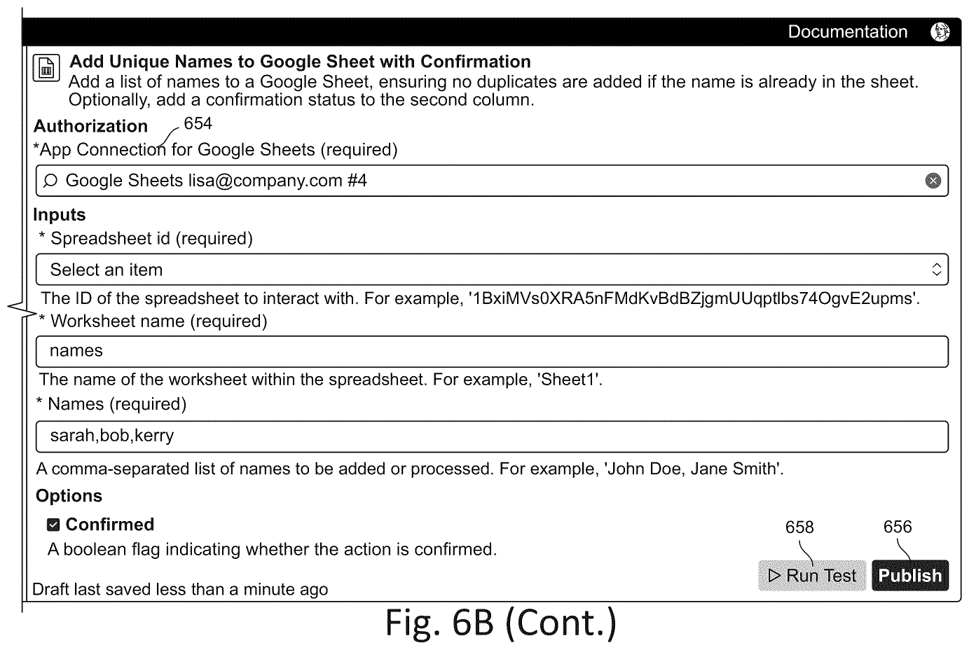

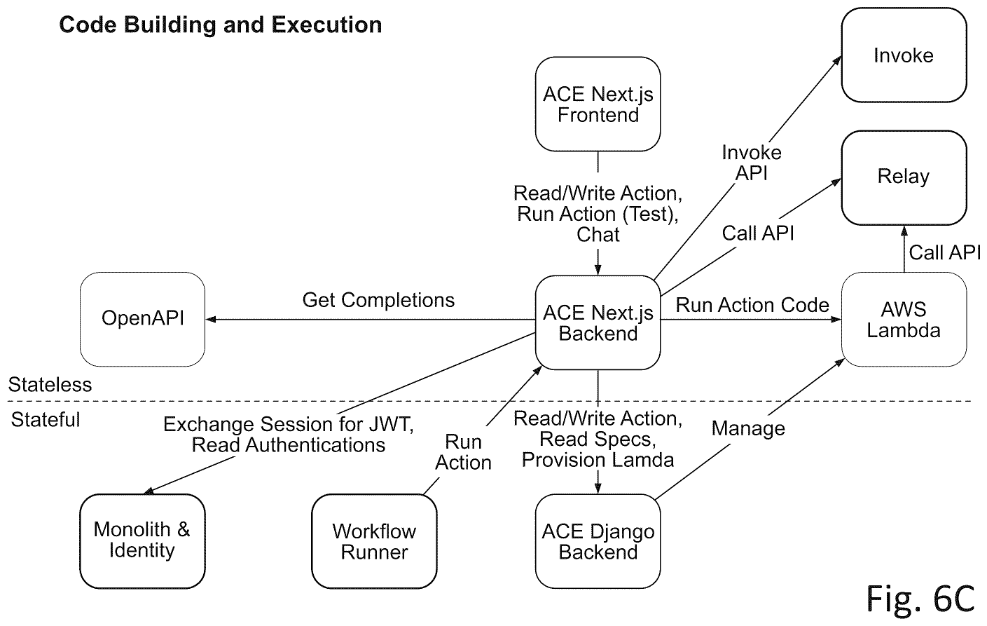

FIGS. 6A and 6B illustrate exemplary GUIs for creating an app extension using a coding interface. This is the third automation approach. When a user describes an action in FIGS. 5A and 5B and dislikes the proposed recommendations, the creation process has to start again since the AI handles one user prompt each time. With the coding interfaces 600 in FIG. 6A and 650 in FIG. 6B, multiple API requests can be processed. As depicted, GUI 600 in FIG. 6A introduces the chat function into the building of app extensions or actions. The user is presented with a chat window 602 to have a chat service with an intelligent agent. The chat service can help the user to build an app extension either through coding. The chat service can also switch the user back to “simple click” processes, i.e., the first and second approaches, to create the app extension. In this way, different ways to create app extensions can be integrated seamlessly.

Referring to FIG. 6B, the user may enter a message (e.g., “get all messages a thread for slack”) in 652, which triggers a chat service. In response, the app extension builder generates a brief text summary in the chat window, notifying the user what has been built. When selecting the “Advanced” option (e.g., 604 in FIG. 6A), the app extension builder allows the user to interact with and run the code. For example, the user may add the inputs in “App Connections” 654 to run the code with option 656. The result of this specific action will then be presented to the user. The user may also test this functionality (e.g., fixing errors) in 658 and use the chat service to design the action that the user needs. Overall the code interface in FIGS. 6A and 6B provide the user more flexibility in creating an app extension. FIG. 6C illustrates an exemplary processing flow for creating an app extension based on code building and execution.

### System Implementation Diagrams

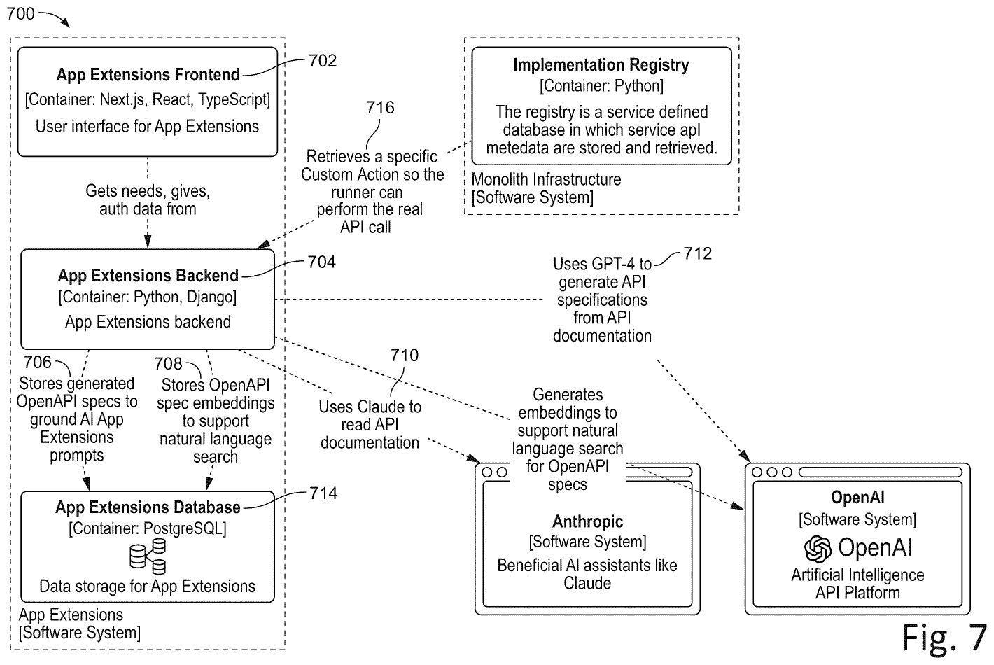

The present disclosure describes systems and methods that help users to create smart and customized workflows. The present system allows a user to create custom-made actions when an existing app does not have the actions the user needs, to use the user's personal app connection account to automatically set the authentication headers, and to share and reuse custom-made actions across the user's apps and among authorized users and communities. The present system also allows the user to view comprehensive API responses, AI-powered recommendations, etc. An app extension system 700 for implementing the foregoing functionalities is depicted in FIG. 7. The diagram in this figure provides a detailed representation of the app extension system, outlining each component and its interactions. System 700 starts with the user's interaction with a frontend 702, which interfaces with both the Django and Next.js backends in 704. In some embodiments, the backend services are responsible for managing extension configurations, searching API specifications, and executing custom actions using AWS Lambda.

AI plays the most significant role in the processing of API reference material and the construction of OpenAPI specifications. The API Specs Crawler gathers API documentation (e.g., in 706, 708), which the API Specs Documentation Reader ‘reads’ using AI (e.g., in 710). This information is transformed into summarized API endpoint documentation, which is then used to generate OpenAPI specifications via the API Specs OpenAPI Spec Generator (e.g., in 712). These specifications are stored in the database 714, ready to be retrieved in near real-time when a user needs to create a custom action (e.g., in 716).

The automated process implemented through the interactions of components in FIG. 7 allows for the processing of a variety of API reference materials, contributing to a rich and growing library of OpenAPI specifications. This enables the app extensions system 700 to assist automators in a highly efficient and effective manner. In addition, the AI's ability to understand and process API documentation may significantly reduce the manual effort required, rendering the creation of custom actions for automation workflows much simpler and faster for end-users.

### Flowchart

FIG. 8 illustrates a flowchart 800 of creating an app extension in automation workflows, according to some embodiments. At step 802, the present system receives a request for creating an app extension from a user. The app extension includes at least one custom action. This custom action can be automatically performed in response to a trigger event, where the custom action and trigger event may be associated with different apps of thousands of connected apps. The trigger is the event that initiates the automation, and the custom action is the task performed as a result of the trigger. For example, upon a trigger event such as receiving an email in a first app, a custom action to be performed includes adding a contact to a second app and/or starting a project in a third app.

At step 804, the present system generates one or more text responses to request additional information or to confirm user requirements. From the gathered user requirements, the present system determines, using one or more trained AI models, one or more existing app extensions and associated parameters from the thousands of connected applications at step 806.

In some embodiments, the existing app extensions may be determined by at least one of semantic search or AI model prompting. In other words, the present system may rely on semantic search alone to obtain the existing app extension suggestions, or supply a list of relevant existing app extensions to one or more AI models and have the AI models to identify one or more appropriate matches from the list. The present system may also perform a semantic search to obtain a list of results (e.g., app extensions) and apply one or more AI models to determine the best app extensions from the list.

In some embodiments, the present system may determine the parameters associated with an app extension by prompting one or more AI models. For example, the present system may concatenate a prompt along with an action description from a user and input the concatenated data to one or more AI models to determine a matching app extension or to create a new one. The prompt may be a meta prompt that defines structured outputs of the AI models. It should be noted that the present system can differentiate between parameter values that are supplied in the action description and parameter values that are left undefined. Usually a follow-up question or a GUI may be presented to the user to obtain additional information.

At step 808, the present system generates one or more first graphical interfaces to present to the user the one or more existing app extensions and associated parameters. The information is presented to the user as a recommendation for soliciting a use selection at step 810. At step 812, the present system determines whether the user accepts or rejects the recommendation.

If the user selects to reject the recommended app extensions, the relevant inputs have been defined (e.g., based on the associated parameters), and the present system can still provide this information to the user to minimize the manual effort from the user. At step 814, the present system can generate one or more second graphical interfaces to provide instructions for the user to create the at least one custom action. The present system also populates values to one or more fields of the one or more second graphical interfaces based on the associated parameters at step 816 and provides the populated values to the user to reduce user input in creating the at least one custom action at 818. On the other hand, if the user decides to accept one of the recommended app extensions, the present system uses this accepted app extension to complete the app extension creation process at step 820.

### Computer-Based Implementation

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used and/or functional programming languages can be used. Electrical memory, such as flash-based memory, can be used.

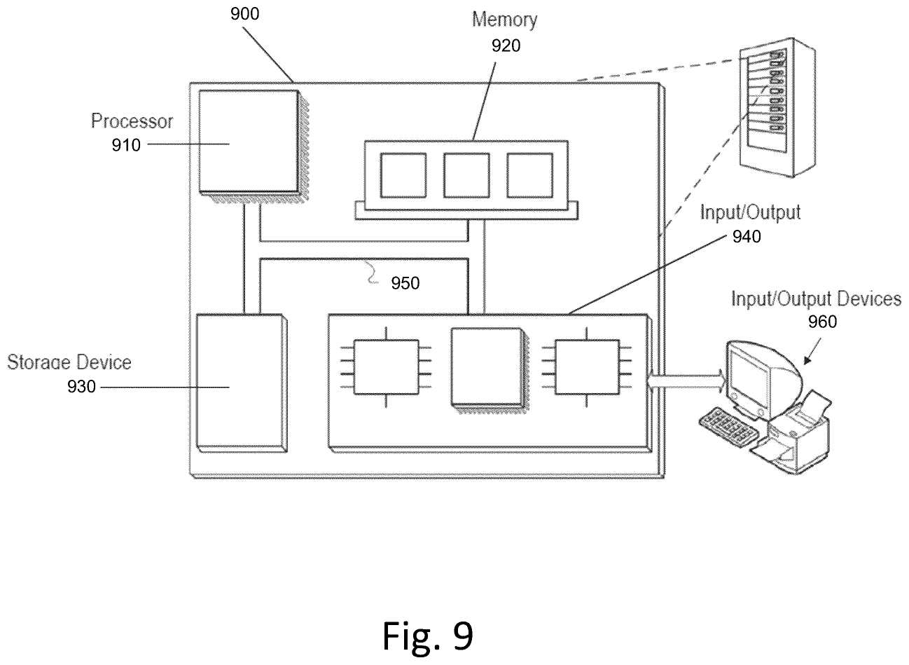

FIG. 9 is a block diagram of an example computer system 900 that may be used in implementing the technology described herein. General-purpose computers, network appliances, mobile devices, or other electronic systems may also include at least portions of the system 900. The system 900 includes a processor 910, a memory 920, a storage device 930, and an input/output device 940. Each of the components 910, 920, 930, and 940 may be interconnected, for example, using a system bus 950. The processor 910 is capable of processing instructions for execution within the system 900. In some implementations, the processor 910 is a single-threaded processor. In some implementations, the processor 910 is a multi-threaded processor. The processor 910 is capable of processing instructions stored in the memory 920 or on the storage device 930.

The memory 920 stores information within the system 900. In some implementations, the memory 920 is a non-transitory computer-readable medium. In some implementations, the memory 920 is a volatile memory unit. In some implementations, the memory 920 is a non-volatile memory unit.

The storage device 930 is capable of providing mass storage for the system 900. In some implementations, the storage device 930 is a non-transitory computer-readable medium. In various different implementations, the storage device 930 may include, for example, a hard disk device, an optical disk device, a solid-state drive, a flash drive, or some other large capacity storage device. For example, the storage device may store long-term data (e.g., database data, file system data, etc.). The input/output device 940 provides input/output operations for the system 900. In some implementations, the input/output device 940 may include one or more network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 960. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, executable code, or other instructions stored in a non-transitory computer-readable medium. The storage device 630 may be implemented in a distributed way over a network, such as a server farm or a set of widely distributed servers, or may be implemented in a single computing device.

Although an example processing system has been described in FIG. 6, embodiments of the subject matter, functional operations, and processes described in this specification can be implemented in other types of digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to a suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special-purpose logic circuitry, e.g., an FPGA (field programmable gate array) or an ASIC (application-specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program can include, by way of example, general or special purpose microprocessors or both, or any other kind of central processing unit. Generally, a central processing unit will receive instructions and data from a read-only memory, a random access memory, or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media, and memory devices, including way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special-purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### TERMINOLOGY

The phraseology and terminology used herein are for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A method for custom action creation in automation workflows comprising:
receiving a request for creating an application extension from a user, the application extension including at least one custom action;
determining, using one or more trained artificial intelligence (AI) models, one or more existing application extensions and associated parameters from a plurality of connected applications;
generating one or more first graphical interfaces to present a recommendation to the user, the recommendation including the one or more existing application extensions and associated parameters;
receiving a selection of the recommendation from the user; and
in response to receiving the selection, creating the application extension based at least on the recommended parameters.

2. The method of claim 1, wherein creating the application extension based at least on the recommended parameters comprises:
in response to the user rejecting the recommended application extensions,
generating one or more second graphical interfaces to provide instructions for the user to create the at least one custom action;
populating values to one or more fields of the one or more second graphical interfaces based on the associated parameters; and
providing the populated values to the user to reduce user input in creating the at least one custom action.

3. The method of claim 1, wherein creating the application extension based at least on the recommended parameters comprises:
in response to the user accepting a recommended application extension, using the accepted application extension to complete creating the application extension.

4. The method of claim 1, wherein determining the one or more existing application extensions and associated parameters comprises performing at least one of semantic search and AI prompting.

5. The method of claim 1, further comprising generating one or more text responses to request additional information or to confirm user requirements, wherein determining the one or more existing application extensions and associated parameters is based at least on the user requirements.

6. The method of claim 1, further comprising synchronizing information of the plurality of connected applications.

7. The method of claim 1, wherein the request for creating the application extension comprises a natural language prompt describing the at least one custom action.

8. The method of claim 1, further comprising generating one or more coding interfaces for a user to run a software program and create the application extension.

9. The method of claim 1, further comprising sharing the application extension with one or more other users.

10. The method of claim 1, further comprising:
training the one or more AI models using secured application programming interface (API) database.

11. A system for custom action creation in automation workflows comprising:
a processor; and
a memory in communication with the processor and comprising instructions which, when executed by the processor, program the processor to:
receive a request for creating an application extension from a user, the application extension including at least one custom action;
determine, using one or more trained artificial intelligence (AI) models, one or more existing application extensions and associated parameters from a plurality of connected applications;
generate one or more first graphical interfaces to present a recommendation to the user, the recommendation including the one or more existing application extensions and associated parameters;
receive a selection of the recommendation from the user; and
in response to receiving the selection, create the application extension based at least on the recommended parameters.

12. The system of claim 11, wherein, to create the application extension based at least on the recommended parameters, the instructions further program the processor to:
in response to the user rejecting the recommended application extensions,
generate one or more second graphical interfaces to provide instructions for the user to create the at least one custom action;
populate values to one or more fields of the one or more second graphical interfaces based on the associated parameters; and
provide the populated values to the user to reduce user input in creating the at least one custom action.

13. The system of claim 11, wherein, to create the application extension based at least on the recommended parameters, the instructions further program the processor to:
in response to the user accepting a recommended application extension, use the accepted application extension to complete creating the application extension.

14. The system of claim 11, wherein, to determine the one or more existing application extensions and associated parameters, the instructions further program the processor to perform at least one of semantic search and AI prompting.

15. The system of claim 11, wherein the instructions further program the processor to generating one or more text responses to request additional information or to confirm user requirements, wherein determining the one or more existing application extensions and associated parameters is based at least on the user requirements.

16. The system of claim 11, wherein the instructions further program the processor to synchronize information of the plurality of connected applications.

17. The system of claim 11, wherein the request for creating the application extension comprises a natural language prompt describing the at least one custom action.

18. The system of claim 11, wherein the instructions further program the processor to generate one or more coding interfaces for a user to run a software program and create the application extension.

19. The system of claim 11, wherein the instructions further program the processor to share the application extension with one or more other users.

20. A computer program product for custom action creation in automation workflows, the computer program product comprising a non-transitory computer-readable medium having computer readable program code stored thereon, the computer readable program code configured to:
receive a request for creating an application extension from a user, the application extension including at least one custom action;
determine, using one or more trained artificial intelligence (AI) models, one or more existing application extensions and associated parameters from a plurality of connected applications;
generate one or more first graphical interfaces to present a recommendation to the user, the recommendation including the one or more existing application extensions and associated parameters;
receive a selection of the recommendation from the user; and
in response to receiving the selection, create the application extension based at least on the recommended parameters.
